(19) United States
(12) Patent Application Publication
(10) Pub. No.: US 2013/0177181 A1
(43) Pub. Date: Jul. 11, 2013

(54) PROTECTING CASE ASSEMBLY WITH FOLDABLE SLIM SPEAKER FOR PORTABLE APPARATUS

(71) Applicant: IN2UIT INC. LTD, New Taipei City (TW)

(72) Inventor: Solomon MARCUS, New Taipei City (TW)

(73) Assignee: IN2UIT INC. LTD, New Taipei City (TW)

(21) Appl. No.: 13/726,411

(22) Filed: Dec. 24, 2012

(30) Foreign Application Priority Data
Jan. 9, 2012 (TW) 101200516

(51) Int. Cl. H04R 1/02

(52) U.S. Cl. CPC H04R 1/02
USPC 381/189

(57) ABSTRACT

A protecting case assembly with foldable slim speaker for portable apparatus includes a protecting case attached with two hinge members and two slim speakers, like electret speakers, each attached with a hinge. Two hinges are correspondingly connected to the two hinge members so as to make the two slim speakers be rotatable between a close position and an open position. Furthermore, a resonance chamber of the protecting case receives a woofer. Next, the protecting case assembly can receive external multimedia signals from a portable apparatus through a Bluetooth module and output the signals through the electret speakers and the woofer to perform high quality sound effects. Therefore, according to the protecting case assembly, the user can use it to protect the portable apparatus whilst conveniently carrying better sound equipment in order to enjoy a high quality audio and video performance anytime and anywhere.

### CROSS-REFERENCES TO RELATED APPLICATIONS

This non-provisional application claims priority under 35 U.S.C. §119(a) on Patent Application No. 101200516 filed in Taiwan, R.O.C. on Jan. 9, 2012, the entire contents of which are hereby incorporated by reference.

### BACKGROUND OF THE INVENTION

1. Technical Field

The present invention relates to a protecting case assembly with foldable slim speaker for portable apparatus, and particularly to a protecting case assembly suitable for receiving and protecting the portable apparatus.

2. Related Art

With the advancement of the technology, portable apparatuses have become almost essential consumer items, such as iPad, tablet computers or other portable apparatuses. The functionality of some portable apparatuses could even replace computers. For example, the portable apparatus can be used not only for general word processing but also to play games or watch videos. However, the audio output device of the portable apparatus is too simple to perform exactly the special sound effects or an atmosphere of the games or the movies. Therefore, users might feel dissatisfied and buy other external audio equipment. However, buying and using external audio equipment in order to obtain a better sound would on one hand limit the using place of the portable apparatus and on the other hand would lose the convenience of carrying and using the portable apparatus.

In addition, most portable apparatuses are operated through a touch panel and text is entered through a virtual keyboard displayed on the screen. However, the area of the touch panel is limited, so users would feel it is inconvenient and uncomfortable to type for prolonged periods. Consequently, many users would buy an external keyboard for the convenience of typing for prolonged periods.

### SUMMARY

An embodiment of the present invention provides a protecting case assembly with foldable slim speaker for portable apparatus, including a protecting case and at least one slim speaker. The protecting case includes a receiving portion, a back, and an extending chamber. A portable apparatus may be disposed in the receiving portion. The back is at the contrary side of the receiving portion and has at least one hinge member. A transmission module is disposed in the extending chamber to receive a multimedia signal from outside. At least one slim speaker includes a hinge corresponding to the at least one hinge member of the protecting case. According to the hinge, the at least one slim speaker is rotatable between a close position and an open position. The close position represents a position closest to the back of the protecting case where the at least one slim speaker is capable of being rotated to. The open position represents a position farthest from the back of the protecting case where the at least one slim speaker is capable of being rotated to. Furthermore, the at least one slim speaker is electrically connected to the transmission module to output the multimedia signal.

Based on the previous description, through combining the protecting case with slim speaker, the user can use the protecting case assembly to protect the portable apparatus and be convenient to carry high-quality audio equipments at the same time. Thus the user can get a high quality audio output anywhere and anytime.

In other embodiment of the present invention, at least one woofer is disposed in the extending chamber and electrically connected to the transmission module to output the multimedia signal, providing the user with better bass sound performance. Furthermore, if the extending chamber is separated to form a resonance chamber to accommodate the at least one woofer, it could produce a bass resonance effect.

In other embodiment of the present invention, a rechargeable battery is disposed in the extending chamber. The rechargeable battery could provide long-term and stable electricity, so the user can use the speakers anytime and anywhere without connecting to an external power supply. The battery also could be a non-rechargeable battery or other equivalent power supplies, and the present invention is not limited thereto.

In other embodiment of the present invention, the at least one hinge member of the protecting case may include an upper pivoting hole and a lower pivoting hole. The hinge of the at least one slim speaker may include a pivot, and the pivot inserts into the upper pivoting hole and the lower pivoting hole. Then, the at least one slim speaker could be rotated between the close position and the open position. The hinge member of the protecting case and the hinge of the at least one slim speaker may be replaced by a flexible circuit board which could also provide a pivot effect to substitute.

In other embodiment of the present invention, the transmission module of the protecting case may be a Bluetooth module that could connect with other Bluetooth module of other portable apparatuses to transfer the multimedia signal. The transmission module may be an equivalent wireless module or a wire connection module such as universal serial bus (USB) to transfer the multimedia signal, and the present invention is not limited thereto.

In other embodiment of the present invention, the at least one slim speaker may be two flexible electret speakers to use as tweeters. Two flexible electret speakers could be positioned side by side on the back of the protecting case. The slim speaker may be other types of slim speaker such as a piezoelectricity speaker, a static electricity speaker, an electro-magnetic speaker, a ribbon speaker, or other equivalent slim speakers. The present invention is not limited thereto.

In other embodiment of the present invention, at least one first magnetic piece is disposed at the back of the protecting case and a first magnet is disposed at the at least one slim speaker. When the at least one slim speaker is rotated to the close position, the first magnet attracts the at least one first magnetic piece to fix the at least one slim speaker at the close position. Furthermore, at least one second magnetic piece is disposed at the back of the protecting case and a second magnet is disposed at the at least one slim speaker. When the at least one slim speaker is rotated to the open position, the second magnet attracts the at least one second magnetic piece to fix the at least one slim speaker at the open position. Therefore, when user carries or uses the protecting case assembly, the at least one slim speaker would not rotate freely and result in inconvenience.

In other embodiment of the present invention, the protecting case assembly may include a Bluetooth keyboard so user might feel more comfortable in prolonged typing. In order to be easy to carry and place, at least one third magnet is disposed at the Bluetooth keyboard and at least one third magnetic piece is disposed at the back of the protecting case. The at least one third magnetic piece is capable of correspondingly attracting the at least one third magnet of the Bluetooth keyboard. That means the Bluetooth keyboard can be assembled with the protecting case assembly to become one device.

In other embodiment of the present invention, the protecting case assembly may include a protecting cover. One end of the protecting cover is fixed to the back of the protecting case and another end of the protecting cover covers the outer peripheral of the receiving portion. Furthermore, the protecting cover may include four plates flexibly connected with each other and the four plates could be folded into a triangular stand. Therefore, the protecting case can stand on the table according to the triangular stand as a backrest without using an additional support stand.

In order to make the features and advantages of the present invention more comprehensible, the present invention is described in detail below with reference to embodiments and the accompanying drawings.

### BRIEF DESCRIPTION OF THE DRAWINGS

The following accompanying drawings are a part of the specification of the present invention and show exemplary embodiments of the present invention. The principle of the present invention is described in combination with the accompanying drawings and specification.

FIG. 1 is a perspective view of a protecting case assembly with foldable slim speaker for portable apparatus according to an embodiment of the present invention;

FIG. 2 is an exploded view from rear of the protecting case assembly according to the embodiment of the present invention;

FIG. 3 is a perspective view of the protecting case assembly in use according to an embodiment of the present invention; and

FIG. 4 is a rear perspective view of the protecting case assembly according to an embodiment of the present invention.

### DETAILED DESCRIPTION

Reference may now be made to embodiments of the present invention in detail, and examples of the embodiments are described in the accompanying drawings. Additionally, wherever possible, in the drawings and detailed description an element/component with the same reference number represents the same or similar part.

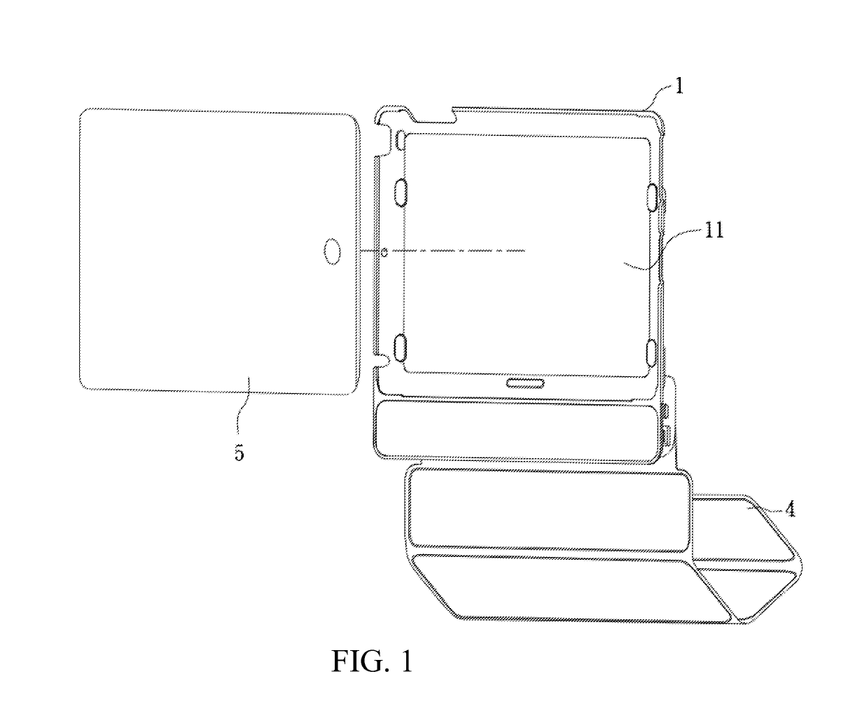

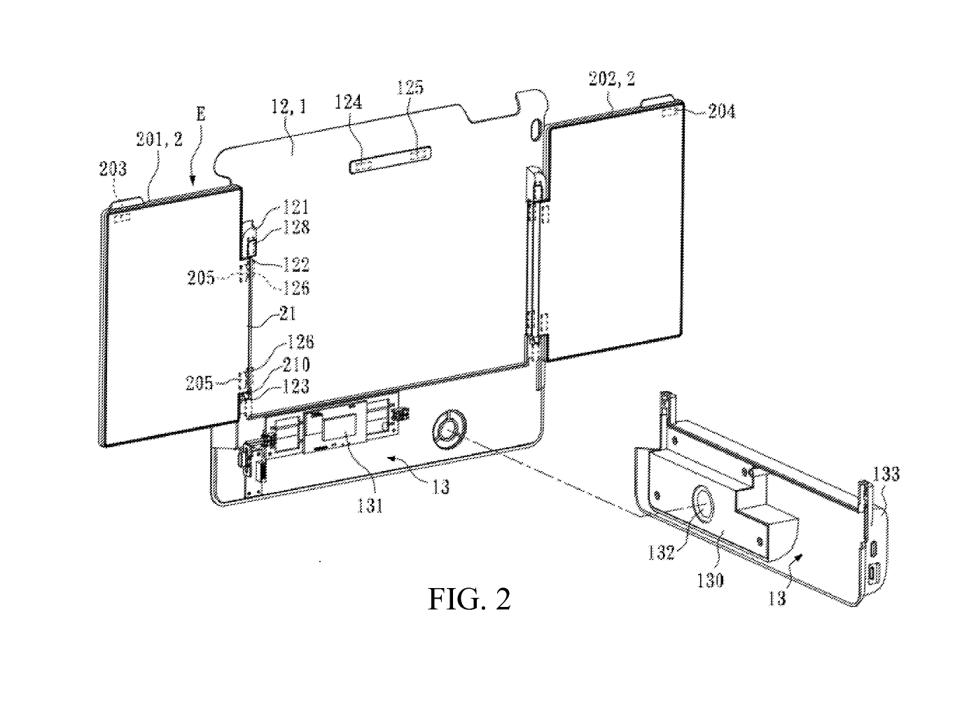

FIG. 1 is a perspective view of a protecting case assembly with foldable slim speaker for portable apparatus according to an embodiment of the present invention, and FIG. 2 is an exploded view from rear of the protecting case assembly. Please refer to FIG. 1 and FIG. 2, in which the protecting case assembly with foldable slim speaker for portable apparatus includes a protecting case 1, two slim speakers 2, and a protecting cover 4. The protecting case 1 includes a receiving portion 11, a back 12, and an extending chamber 13. A portable apparatus 5 is disposed in the receiving portion 11 such as iPad. The back 12 is at the contrary side of the receiving portion 11. As shown in FIG. 2, two hinge members 121 are disposed at the back 12, one at the right side and one at the left side. Each hinge member includes an upper pivoting hole 122 and a lower pivoting hole 123.

A transmission module 131, a woofer 132, and a rechargeable battery 133 are disposed in the extending chamber 13 which is at the lower section of the protecting case 1. In this embodiment, transmission module 131 is a Bluetooth module that could connect with other Bluetooth module of other portable apparatuses to transfer a multimedia signal S. The woofer 132 is set in a resonance chamber 130 that is separated from the extending chamber 13 to achieve the resonance of the woofer 132. The rechargeable battery 133 is a lithium battery to provide long-term and stable electricity, so the user can use the speakers anytime and anywhere. The rechargeable battery can also be other types of rechargeable battery, or can be substituted with a non-rechargeable battery or other equivalent power supplies. The present invention is not limited thereto.

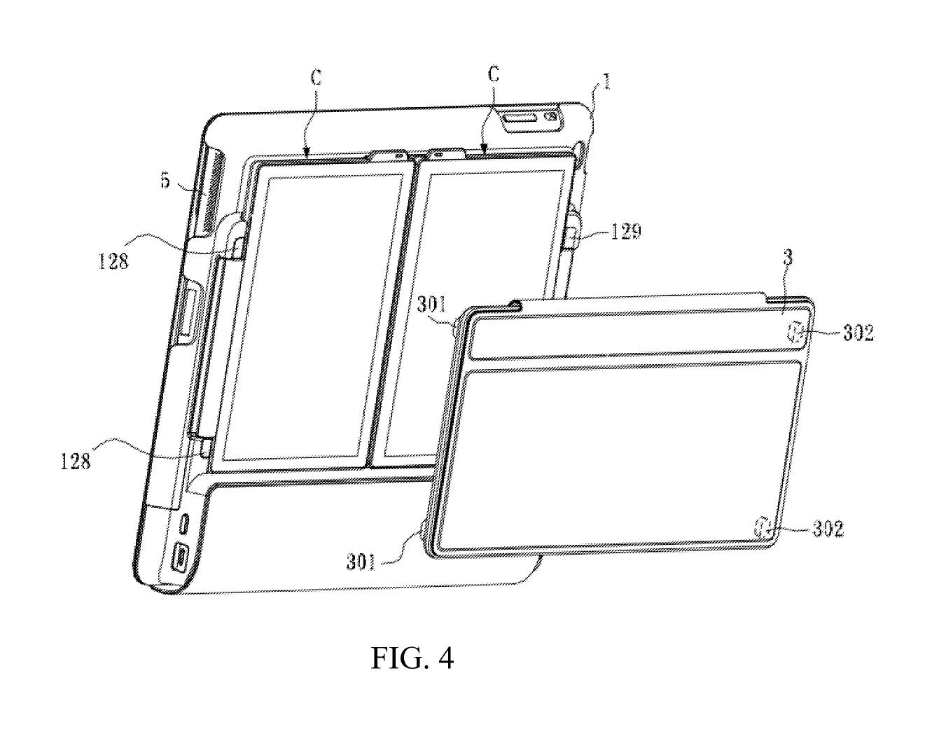

Two slim speakers 2 are two flexible electret speakers 201, 202 to be used as tweeters. Two slim speakers 2 can be other types of slim speakers such as piezoelectricity speakers, static electricity speakers, electro-magnetic speakers, ribbon speakers, or other equivalent slim speakers. The present invention is not limited thereto. The flexible electret speaker 201 includes a hinge 21 and the hinge 21 has a pivot 210. The pivot 210 inserts into the upper pivoting hole 122 and the lower pivoting hole 123. Then, the slim speaker 201 can be rotated between a close position C and an open position E. The close position C represents a position closest to the back 12 of the protecting case 1 where the flexible electret speaker 201 can be rotated to (as shown in FIG. 4). The open position E represents a position farthest from the back 12 of the protecting case 1 where the flexible electret speaker 201 can be rotated to (as shown in FIG. 2). Likewise, the flexible electret speaker 202 has the same structure, so that the flexible electret speaker 202 also can be rotated between the close position C and the open position E.

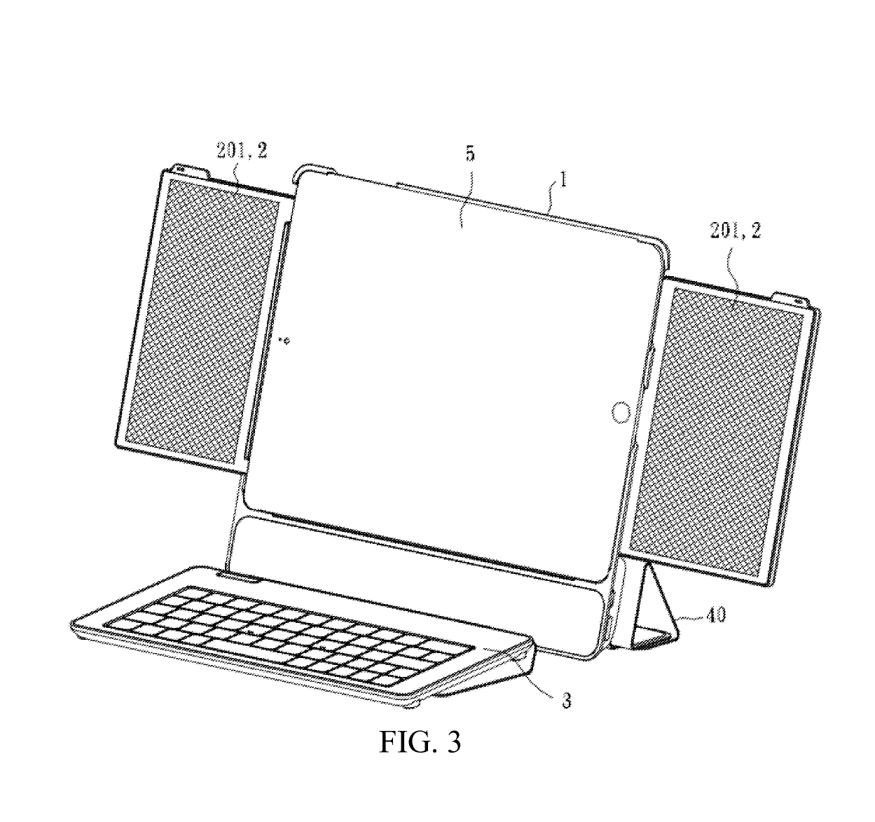

FIG. 3 is a perspective view of the protecting case assembly in use. Please refer to FIG. 2 and FIG. 3, in which two second magnetic piece 126 are disposed at the back 12 of the protecting case 1 and two second magnet 205 are disposed at the flexible electret speaker 201. When the flexible electret speaker 201 is rotated to the open position E, two second magnet 205 attract two second magnetic piece 126 correspondingly to fix the flexible electret speaker 201 at the open position E. Likewise, the flexible electret speaker 202 has the same structure, so that flexible electret speaker 202 also can be fixed at the open position E. As shown in FIG. 3, two flexible electret speakers 201, 202 are both at the open position E. When user sets up the protecting case assembly of the present invention to use, two flexible electret speakers 201, 202 would face to the user so as to clearly output a high quality of sound effects.

Please refer to FIG. 1 and FIG. 3, in which the protecting cover 4 includes four plates flexibly connected with each other. One end of the protecting cover 4 is fixed to the back 12 of the protecting case 1 and another end of the protecting cover 4 covers the outer peripheral of the receiving portion 11 so as to protect the portable apparatus 5 disposed in the receiving portion 11. The free end of the protecting cover 4 can be folded into a triangular stand 40, as shown in FIG. 3. The protecting case 1 can stand on the table according to the triangular stand 40 as a backrest without using other additional support stand.

Accordingly, when user wants to listen to music or watch videos, the protecting case assembly can be assembled as shown in FIG. 3. The protecting case 1 stands on the table by the triangular stand 40 which is formed by folding up the protecting cover 4. Two slim speakers 2 are opened to the open position E to face the user and cooperated with the woofer 132 disposed in the extending chamber 13. The device becomes a small theater, so that user can enjoy a high quality audio and video anytime and anywhere.

In the other hand, in order to meet user's need that can feel more comfortable in prolonged typing, the protecting case assembly further includes a Bluetooth keyboard 3. As shown in FIG. 3, the Bluetooth keyboard 3 can be placed in front of the protecting case assembly, so user can use the portable apparatus 5 like a desktop.

FIG. 4 is a rear perspective view of the protecting case assembly. Please refer to FIG. 2 and FIG. 4, in which two first magnetic pieces 124, 125 are disposed at the back 12 of the protecting case 1, a first magnet 203 is correspondingly disposed at the flexible electret speaker 201, and a first magnet 204 is correspondingly disposed at the flexible electret speaker 202. When the flexible electret speaker 201 is rotated to the close position C as shown in FIG. 4, the first magnet 203 attracts the first magnetic piece 124 and the first magnet 204 attracts the first magnetic piece 125 in order to fix two flexible electret speakers 201, 202 at the close position C. Furthermore, two flexible electret speakers 201, 202 can be positioned side by side on the back 12 of the protecting case 1.

Please refer repeatedly to FIG. 4, in which two flexible electret speakers 201, 202 are positioned at the close position C so the back of the protecting case assembly would be flat. Furthermore, four third magnets 301, 302 are disposed at the Bluetooth keyboard 3 and four third magnetic pieces 128, 129 are disposed at the back 12 of the protecting case 1. Four third magnetic pieces 128, 129 can correspondingly attract four third magnets 301, 302 of the Bluetooth keyboard 3 to attach the Bluetooth keyboard 3 to the back 12 of the protecting case 1. In this embodiment, the Bluetooth keyboard 3 is attached to the back 12 of the protecting case 1 using the magnets. However, in other embodiments, Bluetooth keyboard 3 can be attached to the back 12 of the protecting case 1 using other ways, such as a Velcro, a snap button, or other equivalent structures. The present invention is not limited thereto.

After using, when user wants to carry or storage the protecting case assembly of the present invention, user need only rotate two flexible electret speakers 201, 202 to the back 12 of the protecting case 1 and place the Bluetooth keyboard 3 on the flexible electret speakers 201, 202. Next, folding the protecting cover 4 forward to cover the outer peripheral of the receiving portion 11 and the portable apparatus 5, the protecting case assembly becomes a convenience portable device. Therefore, according to the protecting case assembly, the portable apparatus 5 can retain convenience of carrying and use, whilst simultaneously providing high quality audio equipment and a keyboard.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A protecting case assembly with foldable slim speaker for portable apparatus, comprising:
a protecting case, comprising a receiving portion, a back, and an extending chamber, the back is at the contrary side of the receiving portion and has at least one hinge member, and a transmission module is disposed in the extending chamber to receive a multimedia signal from outside; and
at least one slim speaker, comprising a hinge corresponding to the at least one hinge member of the protecting case, and the at least one slim speaker electrically connects to the transmission module to output the multimedia signal;
wherein the at least one slim speaker is rotatable between a close position and an open position according to the hinge, the close position represents a position closest to the back of the protecting case where the at least one slim speaker is capable of being rotated to, and the open position represents a position farthest from the back of the protecting case where the at least one slim speaker is capable of being rotated to.

2. The protecting case assembly with foldable slim speaker for portable apparatus according to claim 1, wherein at least one woofer is disposed in the extending chamber and electrically connected to the transmission module to output the multimedia signal.

3. The protecting case assembly with foldable slim speaker for portable apparatus according to claim 2, wherein the extending chamber is separated to form a resonance chamber to accommodate the at least one woofer.

4. The protecting case assembly with foldable slim speaker for portable apparatus according to claim 1, wherein a rechargeable battery is disposed in the extending chamber.

5. The protecting case assembly with foldable slim speaker for portable apparatus according to claim 1, wherein the at least one hinge member of the protecting case comprises an upper pivoting hole and a lower pivoting hole, the hinge of the at least one slim speaker comprises a pivot, and the pivot inserts into the upper pivoting hole and the lower pivoting hole.

6. The protecting case assembly with foldable slim speaker for portable apparatus according to claim 1, wherein the transmission module of the protecting case is a Bluetooth module.

7. The protecting case assembly with foldable slim speaker for portable apparatus according to claim 1, wherein the at least one slim speaker is two flexible electret speaker.

8. The protecting case assembly with foldable slim speaker for portable apparatus according to claim 1, wherein at least one first magnetic piece is disposed at the back of the protecting case, a first magnet is disposed at the at least one slim speaker, and when the at least one slim speaker is rotated to the close position, the first magnet attracts the at least one first magnetic piece to fix the at least one slim speaker at the close position.

9. The protecting case assembly with foldable slim speaker for portable apparatus according to claim 1, wherein at least one second magnetic piece is disposed at the back of the protecting case, a second magnet is disposed at the at least one slim speaker, and when the at least one slim speaker is rotated to the open position, the second magnet attracts the at least one second magnetic piece to fix the at least one slim speaker at the open position.

10. The protecting case assembly with foldable slim speaker for portable apparatus according to claim 1 further comprises a Bluetooth keyboard with at least one third magnet, at least one third magnetic piece is disposed at the back of the protecting case, and the at least one third magnetic piece is capable of correspondingly attracting the at least one third magnet of the Bluetooth keyboard.

11. The protecting case assembly with foldable slim speaker for portable apparatus according to claim 1 further comprises a protecting cover, one end of the protecting cover is fixed to the back of the protecting case, and another end of the protecting cover covers the outer peripheral of the receiving portion.

12. The protecting case assembly with foldable slim speaker for portable apparatus according to claim 11, wherein the protecting cover comprises four plates flexibly connected with each other and the four plates are capable of being folded into a triangular stand.
